(19) United States
(12) Patent Application Publication
(10) Pub. No.: US 2007/0101636 A1
(43) Pub. Date: May 10, 2007

(54) Two-piece, flow-through fishing lure

(76) Inventors: Monte Dolence, Polson, MT (US); Wanda Dolence, Polson, MT (US); Lorrie Steinhaus, Parma, ID (US); Ken Steinhaus, Parma, ID (US); Lorrie Steinhaus, Parma, ID (US)

Correspondence Address: PEDERSEN & COMPANY, PLLC, P.O. BOX 2666, BOISE, ID, 83701, US

(21) Appl. No.: 11/527,360

(22) Filed: Sep. 25, 2006

Related U.S. Application Data
(60) Provisional application No. 60/720,001, filed on Sep. 23, 2005.

(51) Int. Cl. A01K 85/00

(52) U.S. Cl. 43/42.06; 43/42.47

(57) ABSTRACT

The invention is a two-piece, flow-through fishing lure, preferably made of plastic. The first, bottom piece is a bent, elongated piece with a slightly dished, downwardly extending front “spoon” section. The bottom piece also has a more greatly dished, horizontally extending back “trough” section with flat, top horizontal edges. The second, top piece is a straight, solid, bulbous piece with a flat bottom and a doomed top. The flat bottom of the top piece cooperates with the flat, top edges of the “trough” section of the bottom piece. This way, there is an open channel which extends through the lure from near the back end of the “spoon” section to the back end of the “trough” section. A curved metal spine is embedded in the bottom piece from near the front to near the back of the lure, with portions of the spine extending out from the bottom piece on its top in the “spoon” area, and on its bottom near the “trough” area. This way, fishing line attaching equipment, and spinners are hooks, for example, may be connected to the lure at these exposed spine locations.

### DESCRIPTION

This application claims priority from prior, co-pending U.S. Provisional Patent Application No. 60/720001, filed Sep. 23, 2005, incorporated herein by reference.

### BACKGROUND OF THE INVENTION

1. Field of the Invention.

This invention relates generally to fishing lures, and more particularly to a two-piece, flow-through fishing lure, preferably made of plastic.

2. Related Art.

Many years ago, there was a popular fishing lure known as TRAIL-A-BAIT™. The old TRAIL-A-BAIT™ lure was a plastic lure with an opening through its body, from the front to the back of the lure (see FIG. 1). This way, as the old lure was pulled through the water by the fishing line which was attached to the front of the lure, water would pass through the body of the lure. The fishing industry lore about the old TRAIL-A-BAIT™ lure was that this rush of water through the body of the lure created a special “gurgle” in the water which attracted big, hungry fish.

The old TRAIL-A-BAIT™ lure was made of three plastic pieces—a curved bottom piece, a flat middle piece and a bulbous, hollow top piece (see FIGS. 1A, 1B, and 1D). In addition, a metal spine was inserted in the middle of the curved bottom part of the lure. The metal spine had several bends in it which exposed it in several regions where it stuck out of the bottom piece of the lure for providing points of attachment of the fishing line and a fish hook, for example, a treble style hook.

It is understood by Applicants that the old TRAIL-A-BAIT™ lure was made by hand, typically by first cutting strips of plastic and then forming the curved bottom piece and the bulbous top piece under application of heat. Then, the three pieces were glued together, top, middle, bottom. As a result of these hand operations, finished, old TRAIL-A-BAIT™ lures were irregular and inconsistent. Often, finished edges didn't match, and gaps in the glued sections existed. Sometimes, portions of what was meant to be the exposed metal spine were covered or filled in by solidified, melted plastic after heating.

Also, the bulbous, hollow top piece of the old TRAIL-A-BAIT™ caused several problems. First, if the glue seal between the top of the flat middle piece and the bottom of the top piece was tight, then there was a permanent bubble of air in the hollow part of the top piece. This bubble would cause the lure to tend to float high in the water, even skip across the surface of the water, when the lure was under tow from the fishing line. This would prevent the fisherman from easily taking the old lure to a desired depth, and is considered a draw-back of the old lure. Second, if the glue seal between the middle piece and the top piece was not tight, then there was a transient bubble in the hollow part, and the size of the bubble would gradually diminish as the top piece filled up with water. This way, the performance of the old lure was variable, depending upon the amount of water which had leaked into the hollow part of the bulbous top piece, and is also considered a drawback of the old lure.

Over time the old TRAIL-A-BAIT™ lure ceased to be produced and marketed. Applicants understand that the old lure has been off the market for many years. Still, however, there is a demand for a lure with performance like the old TRAIL-A-BAIT™ lure. Also, there is a demand for such a lure which can be conveniently and economically manufactured. Also, there is a demand for such a lure with consistent manufacturing results and consistent performance. This invention addresses those needs.

### SUMMARY OF THE INVENTION

The invention is a two-piece, flow-through fishing lure, preferably made of plastic. The first, bottom piece is a bent, elongated piece with a slightly dished, downwardly extending front “spoon” section. The bottom piece also has a more greatly dished, horizontally extending back “trough” section with flat, top horizontal edges. The second, top piece is a straight, solid, bulbous piece with a flat bottom and a domed top. The flat bottom of the top piece cooperates with the flat, top edges of the “trough” section of the bottom piece. This way, there is an open channel which extends through the lure from near the back end of the “spoon” section to the back end of the “trough” section.

A curved metal spine is embedded in the bottom piece from near the front to near the back of the lure, with portions of the spine extending out from the bottom piece on its top in the “spoon” area, and on its bottom near the “trough” area. This way, fishing line connecting equipment, spinners or hooks, for example, may be connected to the lure at these exposed spine locations.

The invention is a new version of the old TRAIL-A-BAIT™ lure. Like the old lure, the new lure is preferably of plastic with an opening through its body, from the front to the back of the lure (see FIG. 2). Also, like the old lure, there is a metal spine inserted in the curved bottom piece of the new lure, with exposed regions where the spine sticks out of the bottom piece of the lure. At the front of the new lure is an eyelet for receiving the fishing line. Near the back bottom of the new lure is preferably attached a treble style hook.

Unlike the old TRAIL-A-BAIT™ lure, however, the new version of the lure is made up at most of just two, preferably plastic, pieces—a curved bottom piece and a curved top piece (see FIG. 2A). Furthermore, the curved top piece is solid, so there is no chance of an air bubble being present there. Also, on the bottom of the curved top piece, and on the top of the curved bottom piece, are optional respective and cooperating projections and indentations, so that the two pieces are “indexed” together for a consistent good fit.

### BRIEF DESCRIPTION OF THE DRAWINGS AND PHOTOS

FIG. 1 is a side, perspective view of the old TRAIL-A-BAIT™ lure.

FIG. 1A is a side, exploded view of the old lure of FIG. 1.

FIG. 1B is a front, exploded view of the old lure of FIG. 1.

FIG. 1C is top view of the old lure of FIG. 1.

FIG. 1D is a back, exploded view of the old lure of FIG. 1.

FIG. 2 is a side, perspective view of the new version of the lure according to one, but not the only, embodiment of the present invention.

FIG. 2A is a side, exploded view of the new lure of FIG. 2.

FIG. 2B is a front, exploded view of the new lure of FIG. 2.

FIG. 2C is a top view of the new lure of FIG. 2.

FIG. 2D is a back, exploded view of the new lure of FIG. 2.

### DETAILED DESCRIPTION OF THE INVENTION

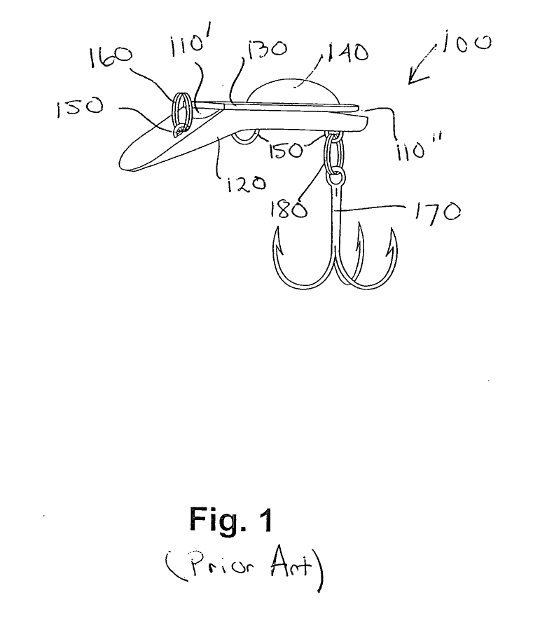

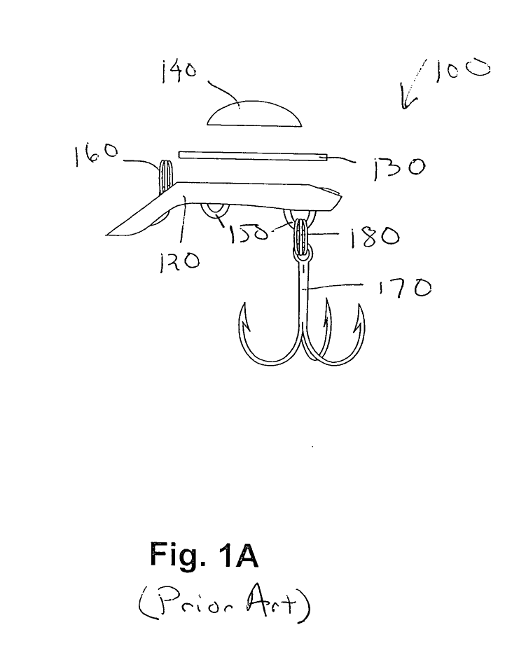

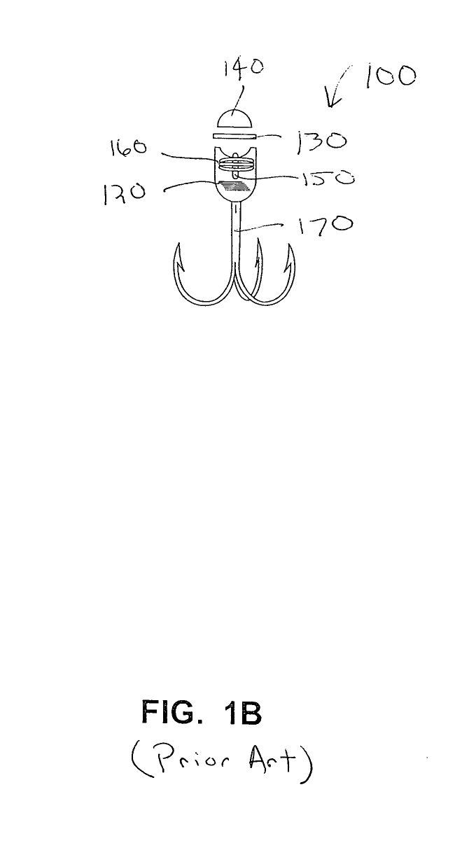

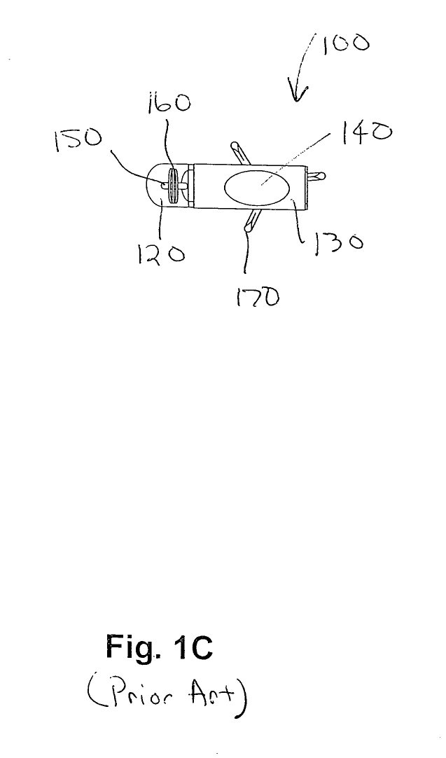

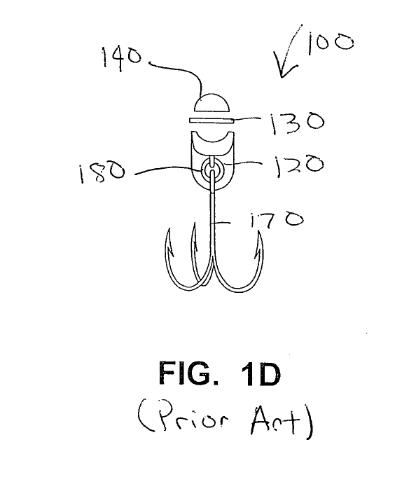

Referring to the Figures, there is depicted the old TRAIL-A-BAIT™ lure 100 in FIGS. 1 and 1A-1D. The old lure had an opening 110 through its body, from the front (110∴) to the back (110″). The old lure was made of three plastic pieces—a curved bottom piece 120, a flat middle piece 130, and a bulbous top piece 140. Top piece 140 was curved concavely, so that, when it was glued to the top of middle piece 130, a volume of air was trapped within it. A metal spine 150 was inserted in the middle of the curved bottom part 120, and extended out from bottom part 120 in several regions to provide points of attachment of the fishing line near the front at eyelet 160 and for treble hook 170 at the back at eyelet 180.

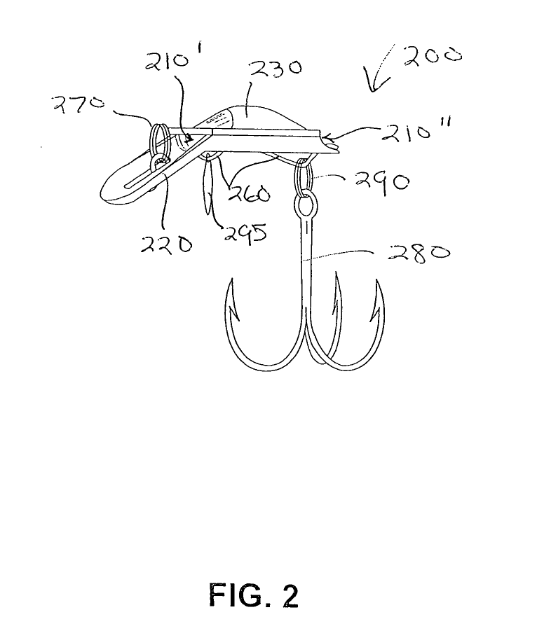

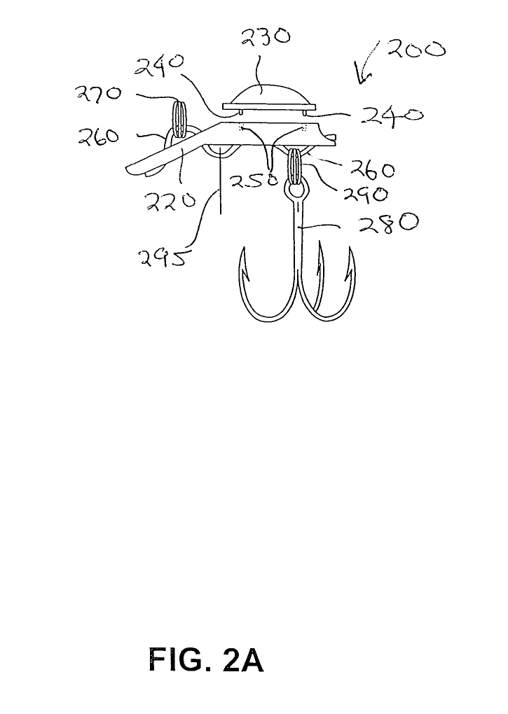

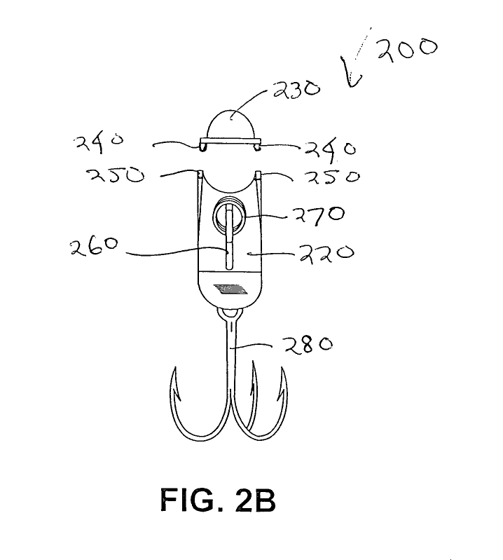

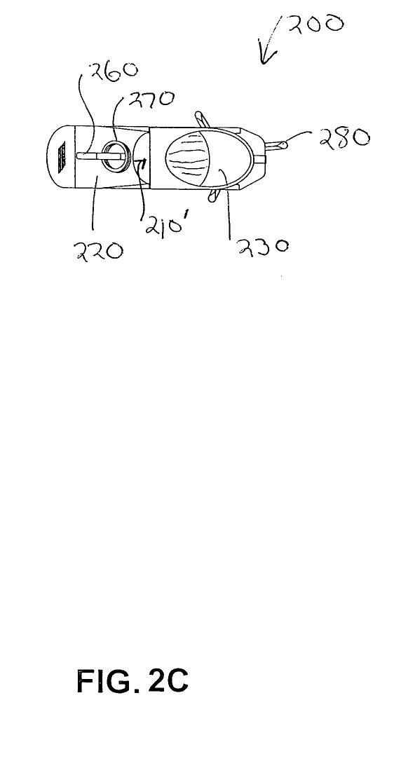

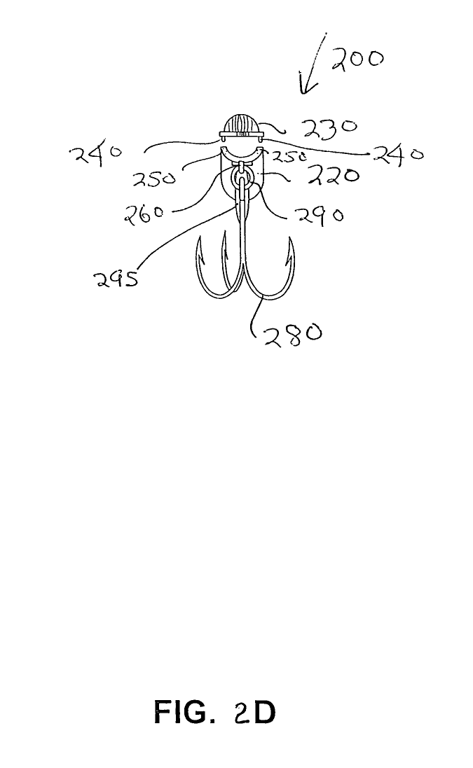

Also, there is depicted one, but not the only, embodiment of the new version 200 of the old lure according to the present invention in FIGS. 2 and 2A-2D. Like the old lure, the new lure 200 is preferably of plastic with an opening 210 through its body, from the front at 210′ to the back at 210″. However, the new lure is made up at most of just two, preferably plastic, pieces—a curved bottom piece 220 and a curved top piece 230. Furthermore, the curved top piece 230 is solid, so there is no chance of an air bubble being present there. Also, on the bottom of the curved top piece 230, and on the top of the curved bottom piece 220, respectively, are optional cooperating projections 240 and indentations 250. This way, the projections and indentations cooperate and interact so that the bottom piece 220 and the top piece 230 are “indexed’ together for a consistently good fit. Alternatively, two projections may be on the bottom to interact with two cooperating indentations on the top. Or, the cooperating projections and indentations may be mixed, with one of each on the top, and one of each of the bottom. Also, alternatively, there may be more or less than two sets of cooperating projections and indentations (in the various possible locations), that is, preferably one or more each of the cooperating sets of projections and indentations.

Also, like the old lure, the new lure has a metal spine 260 inserted in the middle of the curved bottom piece 220, with exposed regions where the spine 260 extends out from the bottom piece 220. At the front of the new lure 200 is an eyelet 270 for receiving the fishing line. Near the back bottom of the new lure 200 is preferably attached a treble style hook 280 at eyelet 290. Also, near the central bottom of the new lure 200 is an optional shiny attractor, or “spinner” 295.

The new lure is made by conventional techniques, including preferably plastic injection molding of curved bottom piece 220, and solid curved top piece 230. Then, the bottom and top pieces may be conventionally glued, or welded or otherwise securely joined together.

Dimensions of the new lure may vary, depending upon the size and type of fish being sought. Relative dimensions are not known to be important, except it is preferred that the opening near the back of the lure be at least about as big as the opening near the front. The opening at the back may even be slightly larger than the opening at the front. This way, water flow through the lure when it is being towed through the water is encouraged.

In an alternate embodiment of the invention, it may be molded in one piece. In this embodiment, the bottom piece 220 and the top piece 230 are joined in the mold. This.way, openings 210′ and 210″ are the result of the finished state of the one-piece mold. Otherwise for this alternate embodiment, the structure of the new lure is the same as described above.

Although this invention has been described above with reference to particular means, materials and embodiments, it is to be understood that the invention is not limited to these disclosed particulars, but extends instead to all equivalents within the broad scope of this disclosure, drawings, and photos.

We claim:

1. A two piece, flow-through fishing lure having a front end and a back end on a generally horizontal axis, said lure, comprising:
a first elongated bottom portion which is bent relative to a horizontal plane, said bottom piece having a slightly dished, downwardly extending front section, and a more greatly dished, horizontally extending back section, said back section having generally flat, top horizontal edges;
a second, solid, bulbous top portion, said bulbous top portion have a generally flat bottom and a domed top, the flat bottom of said top piece cooperating with the generally flat, top horizontal edges of said back section of said first bottom piece;
so that an open channel extends through the lure from near a back end of said front section of said bottom piece to near a back end of the lure.

2. A one-piece, flow through fishing lure having a front end and a back end on a generally horizontal axis, said lure, comprising:
a first elongated bottom portion which is bent relative to a horizontal plane, said bottom portion having a slightly dished, downwardly extending front section, and a more greatly dished, horizontally extending back section, said back section having generally flat, top horizontal edges;
a second, solid, bulbous top portion, said bulbous top portion have a generally flat bottom and a domed top, the flat bottom of said top portion cooperating with the generally flat, top horizontal edges of said back section of said first bottom portion;
so that an open channel extends through the lure from near a back end of said front section of said bottom portion to near a back end of the lure.
